(19) United States
(12) Patent Application Publication
(10) Pub. No.: US 2014/0001158 A1
(43) Pub. Date: Jan. 2, 2014

(54) SYSTEMS AND METHODS FOR REPAIRING ENCASED COMPONENTS

(71) Applicants: Zhipeng Zhang, Latham, NY (US); Andrew Lee Trimmer, Niskayuna, NY (US); Mark James Cintula, Middle Grove, NY (US); Prabhjot Singh, Guilderland, NY (US); Arvind Rangarajan, Rexford, NY (US)

(72) Inventors: Zhipeng Zhang, Latham, NY (US); Andrew Lee Trimmer, Niskayuna, NY (US); Mark James Cintula, Middle Grove, NY (US); Prabhjot Singh, Guilderland, NY (US); Arvind Rangarajan, Rexford, NY (US)

(73) Assignee: GENERAL ELECTRIC COMPANY, SCHENECTADY, NY (US)

(21) Appl. No.: 13/534,062

(22) Filed: Jun. 27, 2012

(51) Int. Cl. B23H 1/04

(52) U.S. Cl. 219/69.15; 219/69.17

(57) ABSTRACT

A system for repairing a component is provided. The system includes an electrochemical machining unit and a tool delivery apparatus. The electrochemical machining unit includes an electrode, a power supply configured to energize the electrode and the component, and a machining solution source configured to pass a machining solution between the component and the electrode. The tool delivery apparatus includes a number of linkage elements pivotally connected and configured to carry the electrode. The tool delivery apparatus further includes an actuation element configured to actuate the linkage elements to move the electrode. A tool delivery apparatus and a method for repairing a component disposed within a case are also presented.

### BACKGROUND OF THE DISCLOSURE

This invention relates generally to systems and methods for repairing components disposed within cases. More particularly, this invention relates to systems and methods for repairing gas turbine engine components.

Gas turbine engine components, such as blades and vanes are critical for safe operation of gas turbine engines. Such gas turbine engine components are typically made from expensive superalloy materials, such as nickel-based superalloy materials to endure high temperatures and high pressures in operation.

After extended service and/or during manufacturing, the gas turbine engine components may have defects caused by effects, such as corrosion, rub cracks, pitting, and foreign objects. As it is difficult and expensive to manufacture the gas turbine engine components, repair of the components are desirable so as to prevent tip liberation and subsequent component failure.

There have been various attempts to repair gas turbine engine components. For example, grinding operations may be employed. However, since gas turbine engine components are generally enclosed in an engine case, typically the engine case may need to be removed to facilitate the repair of the components, which is time consuming. In addition, removal of the engine case for repair of the components also causes undesirable outage time, which adds to the overall cost of the rep air.

Therefore, there is a need for new and improved systems and methods for repairing gas turbine engine components, such as blades and vanes, that are more cost-effective, while still ensuring safe operation of the gas turbine engines.

### BRIEF DESCRIPTION

A system for repairing a component is provided. The system includes an electrochemical machining unit and a tool delivery apparatus. The electrochemical machining unit includes an electrode configured to machine the component, a power supply configured to energize the electrode and the component with opposite electrical polarities, and a machining solution source configured to pass a machining solution between the component and the electrode. The tool delivery apparatus includes a plurality of linkage elements pivotally connected and configured to carry the electrode. The tool delivery apparatus further includes an actuation element configured to actuate the linkage elements to move the electrode.

A tool delivery apparatus is provided. The tool delivery apparatus includes a first, a second and a third linkage element pivotally connected. The second linkage element is disposed between the first and third linkage elements and configured to carry an electrode for electrochemical machining The tool delivery apparatus further includes an actuation element configured to move the second linkage element so as to move the electrode.

A method for repairing a component disposed within a case is provided. The method includes providing a number of linkage elements pivotally connected and carrying an electrode; providing an actuation element to actuate the linkage elements to move the electrode; and passing an electric current between the electrode and the component while passing a machining solution therebetween to perform electrochemical machining for repairing the component.

### BRIEF DESCRIPTION OF THE DRAWINGS

The above and other aspects, features, and advantages of the present disclosure will become more apparent in light of the following detailed description when taken in conjunction with the accompanying drawings in which:

FIGS. 1-2 schematically depict a system for repairing a component enclosed within a compressor case;

FIG. 3 is a schematic diagram of the repair system, in accordance with aspects of the present invention;

FIG. 4 is a perspective diagram of a tool delivery apparatus of the system shown in FIG. 3, in accordance with aspects of the present invention;

FIG. 5 is a schematic cross sectional diagram of a first linkage element of the tool delivery apparatus in FIG. 4 along a line 5-5, in accordance with aspects of the present invention; and

FIGS. 6-8 are schematic perspective diagrams of an electrode, in accordance with various aspects of the present invention.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The modifier “about” used in connection with a quantity is inclusive of the stated value, and has the meaning dictated by context, (e.g., includes the degree of error associated with measurement of the particular quantity).

Moreover, in this specification, the suffix “(s)” is usually intended to include both the singular and the plural of the term that it modifies, thereby including one or more of that term (e.g., “the element” may include one or more elements, unless otherwise specified). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. Similarly, reference to “a particular configuration” means that a particular element (e.g., feature, structure, and/or characteristic) described in connection with the configuration is included in at least one configuration described herein, and may or may not be present in other configurations. In addition, it is to be understood that the described inventive features may be combined in any suitable manner in the various embodiments and configurations.

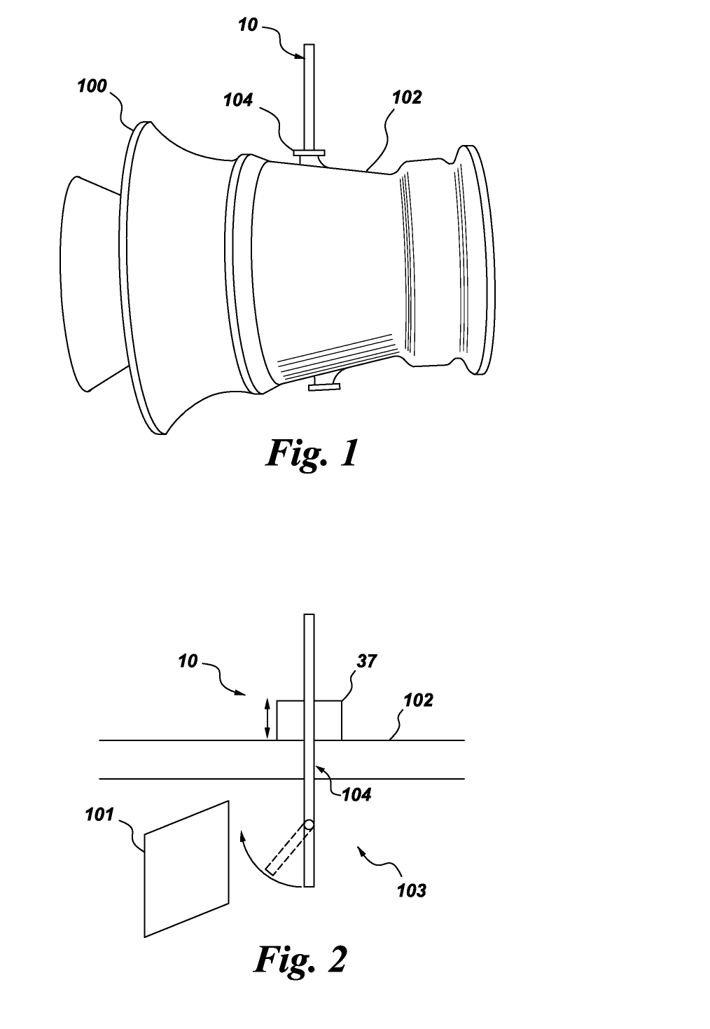

FIGS. 1-2 are schematic diagrams of a system 10 and a component 101 to be repaired in accordance with aspects of the present invention. The component 101 is part of and is disposed within a machine 100. As illustrated in FIGS. 1-2, the machine 100 comprises a case 102 defining a space 103 to accommodate the component 101. The system 10 is configured to extend into the space 103 of the machine 100 through the case 102 to perform repair of the component 101.

Non-limiting examples of the machine 100 includes a gas turbine, a steam turbine, a compressor, or other suitable machines. For the illustrated arrangement, the machine 100 comprises a compressor. For the illustrated example, the component 101 may comprise a blade and/or a vane in the compressor.

The machine 100, such as the compressor may be formed with alternating stages of rotor airfoils or blades and stator airfoils or vanes. The system 10 is configured to perform repair of the component, such as blade(s) in all of the stages of the compressor 100 without removal of the case 102. Further, the system 10 is configured to perform repair of the component, such as vane(s) in the compressor 100. Based on different stages of the target blades and/or vanes, positions of the system 10 relative to the compressor 100 may be easily positioned to reach the target blades and/or vanes.

For example, the system 10 extends into the compressor 100 to repair the target blades and/or vanes 101 through an opening, such as a borescope port 104 defined on the case 102. For particular applications, the system 10 is further configured to reach both leading edges and trailing edges of the target blades and/or vanes for repair operations.

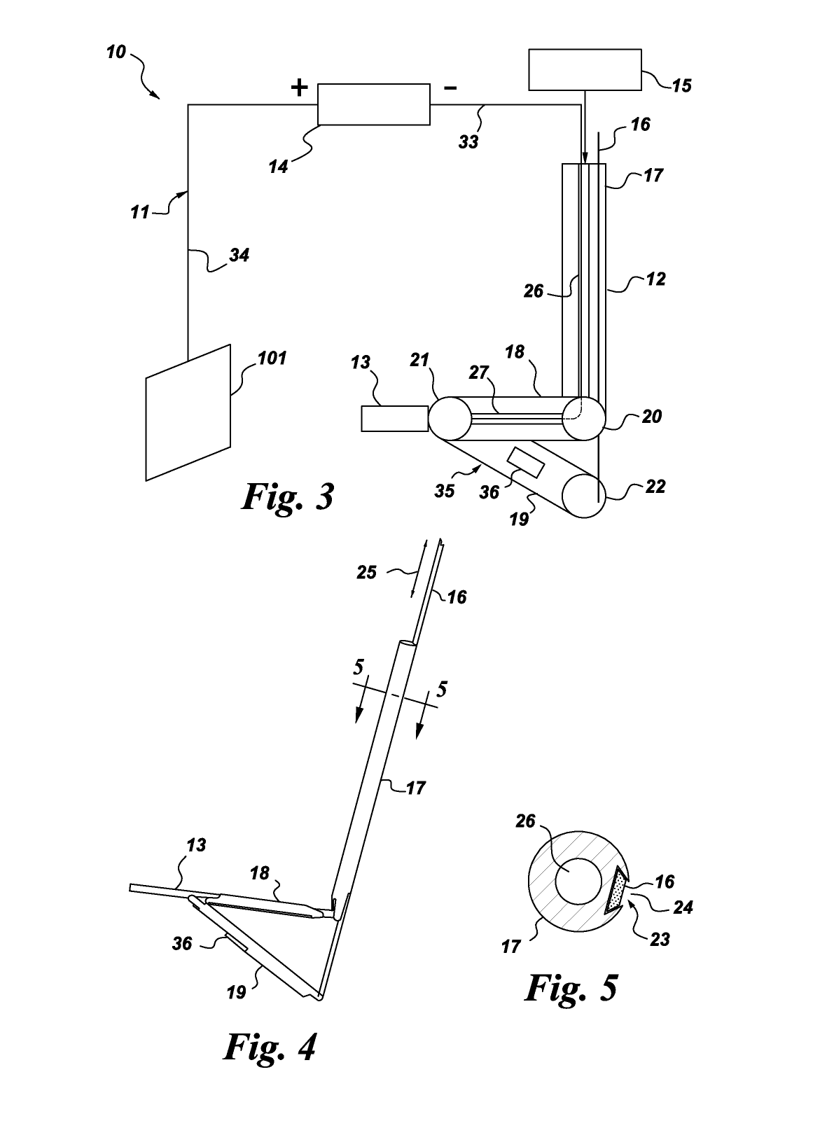

FIG. 3 is a schematic diagram of the system 10 in accordance with aspects of the present invention. As illustrated in FIG. 3, the system 10 includes an electrochemical machining (ECM) unit 11 and a tool delivery apparatus 12. As used herein, the term “ECM” means a process in which an oxidation reaction occurs at a workpiece, such as the component 101 due to a chemical potential difference from an applied electric field, such that material is removed from the workpiece.

The ECM unit 11 is configured to perform repair of the component 101. Typically, the ECM unit 11 is configured to remove material from the component 101 to form desired features with desired shapes on the component 101 to perform the repair. Depending on the specific application, the ECM unit 11 may be configured to deposit material on the component 101.

For the illustrated arrangement, the ECM unit 11 comprises an electrode 13, a power supply 14, and a machining solution source 15. It should be noted that the arrangement of the ECM unit 11 is merely illustrative to show the operation of the electrochemical machining Some elements are not illustrated. For example, a controller (not shown) may be deployed to control the power supply 14 and/or the machining solution source 15 to provide desired electric power and a machining solution, respectively.

The power supply 14 is configured to energize the electrode 13 and the component 101 with opposite electrical polarities. In this example, the electrode 13 and the component 101 are connected to negative and positive poles of the power supply 14 respectively, so that the electrode 11 functions as a cathode and the component 101 acts as an anode in this example. The machining solution source 15 is configured to pass the machining solution, such as an electrolyte through a gap (not labeled) between the electrode 13 and the component 101.

In non-limiting examples, the electrolyte from the machining solution source 15 may comprise an organic electrolyte including, but not limited to ethylene glycol with a halide salt doping. In one example, the halide salt comprises sodium chloride. Additionally, a pump (not shown) may be connected to the machining solution source 15 for controlling the pressure and the flow rate of the machining solution.

Thus, in operation, the electrode 13 moves toward the component 101 but without touching the component 101. The power supply 14 applies a potential gradient and passes an electric current between the electrode 13 and the component 101. The electrolyte from the machining solution source 15 is injected to an area being repaired on the component 101. As the electrolyte passes through the gap between the electrode 13 and the component 101, material from the component 101 is dissolved and removed. The electrode 13 is guided along desired paths to form the desired features in the component 101. In non-limiting examples, the electrode 13 may perform certain repair, such as edge blending or tip cropping on the compressor 101.

In certain applications, the system 10 may or may not comprise a collecting apparatus (not shown) extending into the compressor 101 to collect the machining solution during the repair operation for recovery and circulation. Depending on the specific application, the collecting apparatus may extend into the compressor 101 through the borescope port 104, another borescope port (not shown) adjacent to the borescope port 104, or a bell mouth (not shown) of the compressor 101.

The tool delivery apparatus 12 is configured to deliver or carry the electrode 13 into the compressor 100 to perform the repair, for example, through the case 102 prior to repairing the component 101 and to withdraw the electrode 13 from the case 102 after repairing the component 101. In the illustrated example, the tool delivery apparatus 12 comprises a linkage-based mechanism. Depending on the specific application, the configurations of the linkage-based mechanism may vary. For the example arrangement, as illustrated in FIG. 2, in order to carry the electrode 13 into the compressor 101 through the opening, such as the borescope port 104 on the case 102, the linkage-based mechanism is configured as a straight line to pass through the borescope port 104 having a smaller diameter.

For the example arrangement, as depicted in FIG. 3, after the electrode 13 is delivered into the compressor 101 to perform the electrochemical machining, the configuration of the linkage-based mechanism varies from the straight line configuration so that the electrode 13 is positioned at a proper location relative to the component 101 to be repaired. It should be noted that the arrangements shown in FIGS. 2-3 are merely illustrative. The tool delivery apparatus 12 may have other suitable configurations to perform the repair.

In the illustrated example in FIG. 3, the tool delivery apparatus 12 comprises an actuation element 16, first, second and third linkage elements 17-19, and first, second and third rotating joints 20-22. Alternatively, the tool delivery apparatus 12 may comprise two or more linkage elements although three linkage elements are illustrated in this example. Similarly, one or more rotating joints may also be employed accordingly.

For the illustrated arrangements, the second linkage element 18 is disposed between the first and third linkage elements 17, 19. The first and second rotating joints 20, 21 connect respective distal ends (not labeled) of the first and second linkage elements 17, 18, and the second and third linkage elements 18, 19, so that the first, second and third linkage elements 17-19 moves pivotally from each other.

The actuation element 16 is pivotally connected with a free end (not labeled) of the third linkage element 19 with a distal end thereof via the third rotating joint 22. In non-limiting examples, the first, second and third rotating joints 20-22 may comprise revolute joints each providing a single-axis rotation function. The actuation element 16 is further connected with the first linkage element 17 through a linear joint 23 (shown in FIG. 5) so that the actuation element 16 moves linearly or slides relatively to the first linkage element 17.

In some examples, the linear joint 23 may be a prismatic joint. For example, as illustrated in FIG. 5, the first linkage element 17 defines a slot 24 having a polygonal cross-section. The actuation element 16 has a similar polygonal shape, so as to be accommodated in the slot 24 and slides relative to the first linkage element 17 along an up and down direction 25.

The first, second and third linkage elements 17-19 may have any suitable shapes, such as polygonal or cylindrical shapes. As depicted in FIG. 4, the first, second and third linkage elements 17-19 are cylindrical. The actuation element 16 may also have a suitable shape, such as a polygonal or a cylindrical shape to connect the first linkage element 20. In some applications, each of the first, second and third linkage elements 17-19 and the actuation element 16 may comprise a unitary element. In other applications, one or more of the first, second and third linkage elements 17-19 and the actuation element 16 may comprise more than one element to function as a unitary element.

For the illustrated arrangements in FIGS. 3-4, the electrode 13 is held by the second linkage element 18 with the end thereof connected with the second linkage element 18. The electrode 13 extends beyond the second one 21 of the rotating joints, so that the second linkage element 18 holds the electrode 13 to perform the electrochemical machining. In non-limiting examples, the electrode 13 may be coaxial with the second linkage element 18.

In non-limiting examples, the electrode 13 may be hollow along a length thereof. During the electrochemical machining, in order to facilitate circulation of the electrolyte, each of the first and second linkage elements 17-18 may be hollow and defines a respective inner channel 26, 27 in fluid communication with the machining solution source 15 and the electrode 13 to deliver the electrolyte to pass through the gap between the electrode 13 and the component 101. In other examples, the electrolyte may not be delivered by the first and/or second linkage elements 17-18.

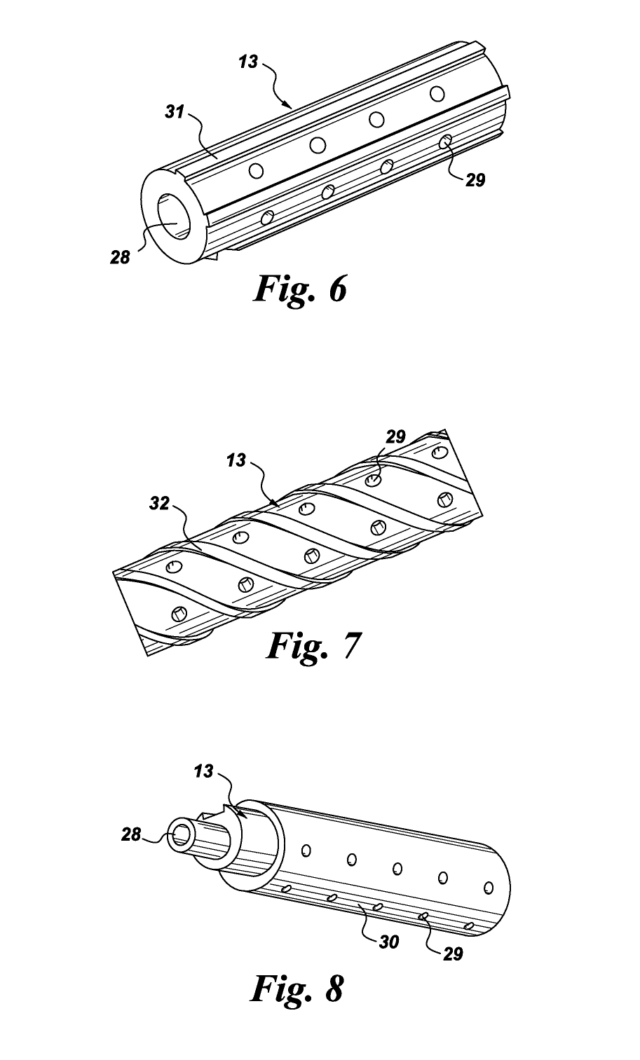

FIGS. 6-8 are schematic perspective diagrams of the electrode 13 in accordance with various aspects of the present invention. As illustrated in FIGS. 6-8, the electrode 13 is hollow and cylindrical, and defines an inner passageway 28 to be in fluid communication with the inner channels 26-27 along the length of the electrode 13. In other examples, the electrode 13 may have other suitable shapes, such as a rectangular shape.

Further, the electrode 13 defines a number of channels 29 passing through a sidewall (not labeled) thereof and in fluid communication with the inner passageway 28 of the electrode 13. Thus, the electrolyte from the inner passageway 28 passes through the channels 29 and through the gap between the electrode 13 and the component 101 to perform the repair. For the illustrated arrangement, the inner passageway 28 is a blind hole to facilitate the passage of the electrolyte through the channels 29.

The arrangements in FIGS. 6-8 are similar. The arrangement in FIG. 8 and the arrangements in FIGS. 6-7 differ in that a mesh 30 is employed in the arrangement in FIG. 7 to guide the electrolyte from the channels 29 to pass through the gap between the electrode 13 and the component 101 and wrap the electrode 13 to define a gap (not shown) between the electrode 13 and the component 101, so as to prevent an electrical short circuit therebetween.

Additionally, for the arrangement shown in FIG. 5, the electrode 13 defines a number of linear bumpers 31 disposed around an outer surface (not labeled) of the electrode parallel to each other to guide the electrolyte. Each linear bumper 31 protrudes from the outer surface and extends along the length of the electrode 13. For the arrangement in FIG. 6, the electrode 13 defines a number of spiral bumpers 32 each protruding from the outer surface and extending around the electrode 13 along the length of the electrode 13. In some applications, the bumpers 31 and 32 include electrical insulating material to prevent an electrical short circuit between the electrode 13 and the component 101 during the repair operation.

In some applications, an electrical connection 33 (shown in FIG. 3) connecting the negative pole of the power supply 14 and the electrode 13 may extend through the inner channels 26-27 of the first and second linkage elements 17-18 to provide the electrical connection between the power supply 14 and the electrode 13. In other examples, the electrical connection 34 connecting the component 101 and the power supply 14 may pass through another opening, such as another borescope port (not shown) adjacent to the borescope 104 to enter into the compressor 101 to provide the electrical connection between the component 101 and the power supply 14.

In this example, another tool delivery apparatus (not shown) similar to the tool delivery apparatus 12 may be employed to deliver the electrical connection 34 into the compressor 101 to provide the electrical connection. Alternatively, any other suitable techniques may be employed to provide the electrical connection between the power supply 14 and the component 101.

For some arrangements, the third linkage element 19 may or may not define an inner channel. In certain applications, a portion of the third linkage element 19 adjacent to the second one 21 of the rotating joints may define a receiving slot 35 to receive a portion of the electrode 13, so that when the tool delivery apparatus 12 is configured as the straight line, the portion of the electrode 13 is accommodated into the receiving slot 35. Additionally, one or more miniature cameras 36 may also be disposed on the third linkage element 19 to monitor the circumstances within the compressor 101, for example to monitor the repair operation by the electrode 13.

Accordingly, during the repair operation, as illustrated in FIG. 2, the tool delivery apparatus 12 is configured as a straight line at the beginning and extends into the compressor 101 to reaches a proper position therein. In this state, the second linkage element 18 holds one end of the electrode 13 and a portion of the electrode 13 is accommodated into the receiving slot 35 defined in the third linkage element 19. In non-limiting examples, the second and third linkage elements 18-19 may be entirely disposed within the compressor 100. For the illustrated arrangement, the first linkage element 17 extends beyond the case 102 of the compressor 100.

After the tool delivery apparatus 12 reaches a desired position, the actuation element 16 moves upward linearly along the first linkage element 17 and actuates the end of the third linkage element 19 connected with the actuation element 16 to move upwardly through the third one 22 of the rotating joints. In certain applications, in order to control the direction of movement of the third linkage element 19, the third rotating joint 22 includes an off-center joint. Additionally, other suitable mechanisms may also be used to control the movement of the third linkage element 19.

Further, in operation, the end of the third linkage element 19 connected with the second linkage element 18 deviates from its original position and moves away from the first linkage element 17 to drive the second linkage element 18 carrying the electrode 13 moves upwardly along an arc curve to a desired position through the first and second rotating joints 20-21.

In non-limiting examples, the second linkage element 18 may move to a position where the angle between the first and second linkage elements is about 90°. In other examples, the angle between the first and second linkage elements may be in a range of about 0° and to about 180°. Subsequently, when the second linkage element 18 carrying the electrode 13 is in position, the ECM unit 11 starts to perform the electrochemical machining for repair.

After finishing the repair, the actuation element 16 moves downwardly along the first linkage element 17 to actuate the second and third linkage elements 18-19 move towards the first linkage element 17 through the first, second and third rotating joints 20-22 until the tool delivery apparatus 12 returns to its original configuration, for example, a straight line configuration. During this process, the ends of the second and third linkage elements 18-19 adjacent to the second rotating joint 21 moves towards and away from the actuation element. Finally, the tool delivery apparatus 12 moves upwardly out of the compressor 100 through the borescope port 104 of the case 102.

In some embodiments, during repair, the first linkage element 17 may be controlled manually to move up and down and/or rotate so as to move the tool delivery apparatus 12 linearly and/or rotationally to a desired position in the compressor 101. In certain applications, as illustrated in FIG. 2, an adjusting element 37 may be disposed on the case 102 to hold and automatically control the first linkage element 17 to move linearly and/or rotationally. In some examples, the adjusting element 37 may also be connected with the actuation element 16 to control the movement of the actuation element 16. In one non-limiting examples, the adjusting element 37 is magnetically attached to the case 102. In addition, as depicted in FIG. 4, the second linkage element 18 also moves relative to the first linkage element 17 along the arc curve in addition to movement with the first linkage element 17, such that the tool delivery apparatus 12 has three degrees of freedom (DOF) and increases the flexibility thereof.

For some arrangements, the first, second and third linkage elements 17-19 and the actuation element 16 may be rigid to perform the repair. Alternatively, one or more of the first, second and third linkage elements 17-19 and the actuation element 16 may be flexible. For example, two linkage elements, such as the first and second linkage elements 17-18 may be employed to perform the repair. The actuation element 16 may be flexible to drive the second linkage element 18 carrying the electrode 13 to move in position.

Beneficially, the system 10 employs the ECM unit 11 to perform the repair to improve the repair efficiency and reduce downtime of the compressor 100. Further, the system 10 employs the linkage-based tool delivery apparatus 12 configured to repair the component 101 in one or more the blades and the vanes of the compressor 100 and to carry the electrode 13 into the compressor 100 through the opening, such as the borescope port 104 of the case 102. In addition, the tool delivery apparatus 12 employs the linkage elements 17-19 and the actuation element 16 to cooperate to move the electrode 13 in position to perform the repair. Beneficially, the tool delivery apparatus 12 has a relatively simple structure, and adjusts configurations depending on the specific application. This beneficially increases the flexibility of the system 10.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A system for repairing a component, the system comprising:
an electrochemical machining unit comprising:
an electrode configured to machine the component,
a power supply configured to energize the electrode and the component with opposite electrical polarities, and
a machining solution source configured to pass a machining solution between the component and the electrode; and
a tool delivery apparatus comprising:
a plurality of linkage elements pivotally connected and configured to carry the electrode, and
an actuation element configured to actuate the linkage elements to move the electrode.

2. The system of claim 1, wherein the component is disposed within a case, and wherein the tool delivery apparatus is configured to advance the electrode through the case prior to repairing the component and to withdraw the electrode from the case after repairing the component.

3. The system of claim 2, wherein the component comprises a blade or a vane and is disposed within a compressor that includes the case, and wherein the tool delivery apparatus enters into the compressor through a borescope port on the case.

4. The system of claim 1, wherein the tool delivery apparatus further comprises a plurality of rotating joints configured to connect the linkage elements with the actuation element.

5. The system of claim 4, wherein the tool delivery apparatus comprises a linear joint configured to connect the actuation element and one of the linkage elements.

6. The system of claim 5, wherein the rotating joints comprise revolute joints, and wherein the linear joint comprises a prismatic joint.

7. The system of claim 4, wherein the linkage elements comprise first, second and third linkage elements, wherein the second linkage element is configured to carry the electrode and is disposed between the first and third linkage elements.

8. The system of claim 7, wherein the second linkage element connects the first and third linkage elements via a first and a second one of the rotating joints, wherein the actuation element is connected with the third linkage element via a third one of the rotating joints, and wherein the actuation element is connected with the first linkage element via the linear joint.

9. The system of claim 7, wherein the actuation element is configured to slide along the first linkage element, so as to drive the second linkage element to move by actuating the third linkage element, and wherein an angle between the first and second linkage elements is in a range of about 0° to about 180°.

10. The system of claim 7, wherein an end of the second linkage element and an end of the third linkage element that are adjacent to the second one of the rotating joints are configured to move towards and away from the actuation element.

11. The system of claim 7, wherein each of the first and second linkage elements define a respective inner channel in fluid communication with one another to pass the machining solution between the electrode and the component.

12. The system of claim 11, wherein an electrical connection connecting the power supply and the electrode passes through the inner channels of the first and second linkage elements.

13. The system of claim 7, wherein the third linkage element defines a receiving slot configured to receive a portion of the electrode when the tool delivery apparatus is configured as a straight line.

14. The system of claim 7, wherein the component is part of and is disposed within a machine, and wherein the tool delivery apparatus further comprises an adjusting element configured to hold the first linkage element on the machine and drive the first linkage element to move.

15. A tool delivery apparatus comprising:
a first, a second and a third linkage element pivotally connected, the second linkage element being disposed between the first and third linkage elements and configured to carry an electrode for electrochemical machining; and
an actuation element configured to move the second linkage element so as to move the electrode.

16. The tool delivery apparatus of claim 15, further comprising a plurality of rotating joints and a linear joint, wherein the second linkage element connects the first and third linkage elements via a first and a second one of the rotating joints, wherein the actuation element is connected with the third linkage element via a third one of the rotating joints, and wherein the actuation element is connected with the first linkage element via the linear joint.

17. The tool delivery apparatus of claim 16, wherein the actuation element is configured to slide along the first linkage element so as to drive the second linkage element to move by actuating the third linkage element, and wherein an angle between the first and second linkage elements is in a range of about 0° to about 180°.

18. The tool delivery apparatus of claim 15, further comprising a plurality of rotating joints, wherein an end of the second linkage element and an end of the third linkage element adjacent to a second one of the rotating joints are configured to move towards and away from the actuation element.

19. The tool delivery apparatus of claim 15, wherein each of the first and second linkage elements defines a respective inner channel in fluid communication with one another.

20. A method for repairing a component disposed within a case, the method comprising:
providing a plurality of linkage elements pivotally connected and carrying an electrode;
providing an actuation element to actuate the linkage elements to move the electrode; and
passing an electric current between the electrode and the component while passing a machining solution therebetween to perform electrochemical machining for repairing the component.

21. The method of claim 20, wherein the linkage elements comprise a first, a second and a third linkage element, wherein the second linkage element is configured to carry the electrode and is disposed between the first and third linkage elements, and wherein the actuation element is configured to slide along the first linkage element to drive the second linkage element to move by actuating the third linkage element.

22. The method of claim 20, further comprising introducing the machining solution through an inner channel defined within the first linkage element and through an inner channel defined within the second linkage element for passing the machining solution between the electrode and the component.

23. The method of claim 20, wherein the component comprises a blade or a vane in a compressor, and wherein the case comprises a compressor case.
